(19) United States
(12) Patent Application Publication
(10) Pub. No.: US 2026/0259426 A1
(43) Pub. Date: Sep. 3, 2026

(54) DISPLAY SYSTEM FOR 3D DISPLAY

(71) Applicant: Goertek Electronics Inc., Santa Clara, CA (US)

(72) Inventors: Kun GAO, Santa Clara, CA (US); Yi ZHANG, Santa Clara, CA (US)

(73) Assignee: Goertek Electronics Inc., Santa Clara, CA (US)

(21) Appl. No.: 19/664,870

(22) Filed: Apr. 30, 2026

(51) Int. Cl. G02B 30/25

(52) U.S. Cl. CPC G02B 30/25

(57) ABSTRACT

In 3D display, a projection of each of a plurality of target relay images is calculated based on optical parameters of a display system including a microlens array. Each target relay image includes an array of intensity values representing an optical image to be formed by the microlens array. The projection is a calculated image array corresponding to an image to be displayed on a display device. Each projection is a conjugate of the respective target relay image. A total calculated image array is determined based on the calculated image arrays. A display image is generated on the display device based on the total calculated image array. A plurality of relay images are formed from the display image by the microlens array. Each relay image corresponds to the respective target relay image. A plurality of virtual images corresponding to the relay images are formed by an optical system.

### TECHNICAL FIELD

The present disclosure describes embodiments generally related to near eye display technology.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Near eye display (NED) devices are being developed to provide an improved user experience in fields such as augmented reality (AR) and virtual reality (VR). The NED devices can include various wearable devices, such as a head mounted display (HMD) device, smart glasses, and the like. In an example, an HMD device includes a relatively small display device and optics that can create a virtual image in the field of view of one or both eyes. To the eye, the virtual image appears at a distance and appears larger than the relatively small display device.

### SUMMARY

Aspects of the disclosure provide display systems configured for three-dimensional (3D) display. A display system includes a microlens array including a two-dimensional array of lenses configured to form a plurality of relay images based on light beams from a display device that corresponds to an image. The display system includes an optical system configured to form a plurality of virtual images. Each of the plurality of virtual images corresponds to a respective one of the plurality of relay images. The microlens array is disposed between the optical system and the display device. The optical system includes one or more lenses including a plurality of surfaces and one or more polarization-selective elements. The plurality of relay images are located at different positions along an optical axis of the display system. The plurality of virtual images are located at different positions (e.g., virtual positions) along the optical axis of the display system.

Aspects of the disclosure also provide methods for three-dimensional (3D) display. A method includes calculating a projection of each of a plurality of target relay images based on optical parameters of a display system including a microlens array. Each of the plurality of target relay images includes an array of intensity values representing an optical image to be formed by the microlens array. The projection is a calculated image array corresponding to an image to be displayed on a surface of a display device. Each projection is a conjugate of the respective target relay image in the plurality of target relay images. The method includes determining a total calculated image array based on the calculated image arrays. The method includes generating a display image on the surface of the display device based on the total calculated image array. The method includes forming, by the microlens array, a plurality of relay images from the display image on the surface of the display device. Each of the plurality of relay images is an optical image corresponding to a respective one of the plurality of target relay images. The method includes forming a plurality of virtual images by an optical system. Each of the plurality of virtual images corresponds to a respective one of the plurality of relay images.

The microlens array is disposed between the optical system and the display device.

### BRIEF DESCRIPTION OF THE DRAWINGS

Further features, the nature, and various advantages of the disclosed subject matter will be more apparent from the following detailed description and the accompanying drawings in which:

FIG. 1A shows an example of a display system including an Alvarez lens and an optical system according to an aspect of the disclosure.

FIG. 1B shows an example of an optical system according to an aspect of the disclosure.

FIG. 2 shows a display system in a side view according to an aspect of the disclosure.

FIG. 3 shows a multi-layer film according to an aspect of the disclosure.

FIG. 4 shows a multi-layer film according to an aspect of the disclosure.

FIG. 5 shows some examples of optical parameters of a display system according to an aspect of the disclosure.

FIG. 6 shows modulation transfer functions of the display system according to an aspect of the disclosure.

FIG. 7 shows an example of the lateral chromatic aberration of the display system according to an aspect of the disclosure.

FIG. 8 shows an example of field curvature plots for the display system according to an aspect of the disclosure.

FIG. 9 shows an example of distortion plots for the display system according to an aspect of the disclosure.

FIG. 10 shows a display system in a side view along with a plurality of relay images according to an aspect of the disclosure.

FIG. 11 shows an example of illustrating a light field elemental image array generation algorithm according to an aspect of the disclosure.

FIG. 12 shows an example of light field display simulation according to an aspect of the disclosure.

FIG. 13 shows a flow chart outlining a process (1300) according to an aspect of the disclosure.

### DETAILED DESCRIPTION

Descriptions of terms in this disclosure are provided as examples only and are not intended to limit the scope of the disclosure.

The present disclosure describes aspects generally related to near eye display technology, including, for example, display systems (e.g., light field display systems) for three-dimensional (3D) imaging in extended reality (XR), virtual reality (VR) systems, augmented reality (AR) systems, and the like.

In various examples, a display system including an optical system (e.g., an ER optical system, a VR optical system, an AR optical system) used for ER, VR, AR, and the like includes an image source and lenses (also referred to as optical lenses, imaging lenses, or the like). Light emitted from the image source is refracted and magnified through the lenses before entering a light receiver, such as a human eye for imaging. In some examples, the image source is a display screen, such as a screen of a liquid crystal display (LCD) device, a micro organic light emitting diode (OLED) display screen, or the like. The display screen produces patterns such as images on surface(s). The surface(s) may be planar, curved, and the like. In an example, the images are two-dimensional (2D) images on a flat screen. In an example, the images are on a curved screen. In an example, the image source produces a 2D image, and a virtual image formed by the display system is two-dimensional with a fixed virtual image distance. In an example, the virtual image is magnified, and thus a size of the virtual image is larger than a size of the 2D image on the image source.

To pursue immersion, in various examples such as gaming environments, a display system including an optical system used for ER, VR, AR, and the like are to display three-dimensional (3D) scenes. However, in some scenarios such as described above, the display system only produces a 2D image at a fixed virtual image distance. In related technologies, software including algorithms is used to cause a depth difference between images formed by a left-eye and a right-eye of a viewer to achieve a binocular disparity display, which the brain merges into a perceived 3D scene. The perceived 3D scene is different from a true 3D scene where the virtual images are formed based on light rays from true 3D objects. In some examples, this situation in the binocular disparity display causes a serious vergence-accommodation conflict (VAC) (also referred to as accommodation-vergence conflict) due to the mismatch between the eye's focus point (also referred to as accommodation) and binocular convergence (also referred to as vergence), resulting in user discomfort such as dizziness during use.

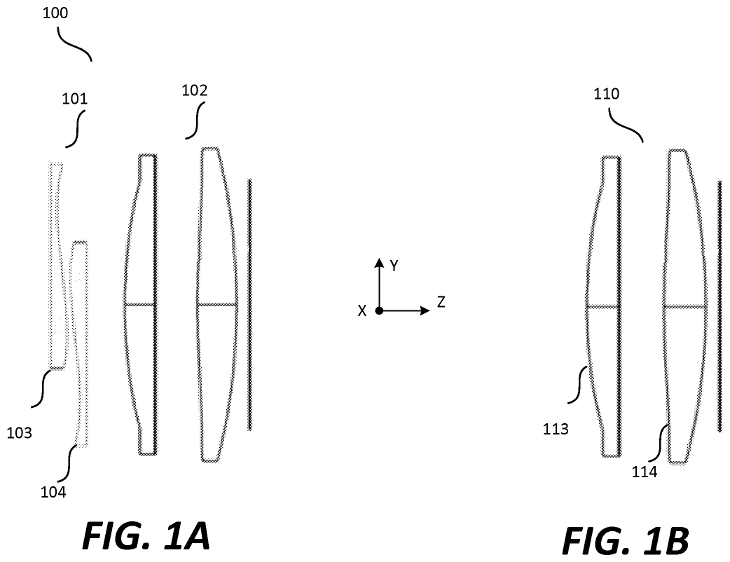

To address the VAC problem in 3D scenes, varifocal techniques may be applied. Varifocal techniques include, for example, Alvarez lenses, moving lenses in a Pancake system (e.g., a Pancake optical system) back and forth, and the like that are used to vary the focal distance such as shown in FIGS. 1A-1B. FIG. 1A shows an example of a display system (100) including an Alvarez lens (101) and an optical system (102). In an example, the Alvarez lens (101) includes a portion (103) and a portion (104) that are configured to move along a Y axis that is perpendicular to an optical axis of the display system (100). The optical axis is along a Z axis. In an aspect, a display system or an optical system is referred to as a folded system when light rays are folded in the display system or the optical system. In an example, light rays are folded in the optical system (102), and the optical system (102) and the display system (100) are referred to as folded systems.

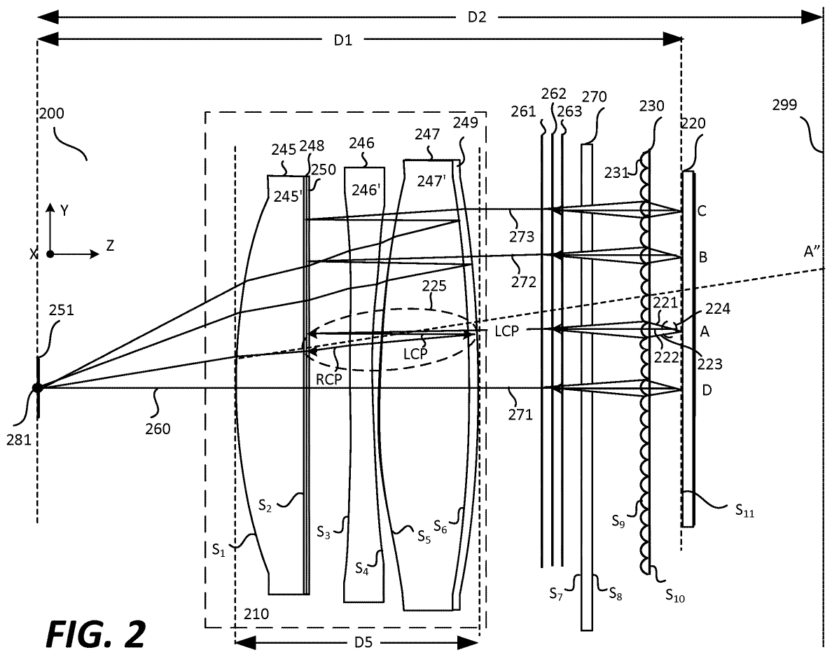

FIG. 1B shows an example of an optical system (e.g., a folded optical system) (110). In an example, the folded optical system (110) includes a lens (113) and a lens (114) that are configured to move along the Z axis that is the optical axis of the folded optical system (110). The folded optical system (110) may also be referred to as a Pancake system and is described in further detail in FIG. 2. In an example, a display system or an optical system is referred to as a Pancake system when a total thickness of the display system or the optical system is less than a threshold. In some examples, the optical system (100) is a Pancake system.

These methods in related technologies such as shown in FIGS. 1A-1B use eye-tracking functionality to address the VAC problem. In various examples of a varifocal process, eye tracking captures the eye gaze, an algorithm calculates the binocular convergence distance, for example, based on the eye gaze, a lens displacement is calculated, and a signal drives the lens to vary focus so that the virtual image distance matches eye convergence. However, these varifocal methods include rapid switching of a single 2D image plane in various examples, and thus the system is complex, slow, and optical performance characteristics such as field of view (FOV) and modulation transfer function (MTF) change after focusing, resulting in a relatively large gap as compared to a true 3D scene.

In an aspect, light field display includes display technologies that reconstruct 3D scenes in space using optical tracking, and addresses the VAC issues in extended reality (XR) systems. The present disclosure provides examples of a light field display method based on a display system including an optical system employing a folded optical architecture (also referred to as Pancake optical architecture) as described in FIG. 2. Combined with image coding algorithms, the display system is configured to simultaneously display a plurality of virtual images for a viewer at different virtual image planes that correspond to different focal planes. For example, a number of the plurality of virtual images is from 2 to 10, such as 6. In an example, the virtual image distances of the plurality of virtual images range from approximately −5 diopters (D) to 0D. In an example, −5D corresponds to approximately 0.2 meters (m) from the light receiver, such as the eye of the viewer, and 0D corresponds to infinity from the light receiver. This represents a true 3D display that alleviates the VAC problem.

In an aspect, a method for 3D display employs a projection synthesis approach. The method includes calculating a projection of each of a plurality of target relay images based on optical parameters of a display system including a microlens array. Each of the plurality of target relay images is a set of intensity values (or an array of intensity values) representing a desired optical image to be formed by the microlens array, rather than a physically formed image. In various examples, the projection is a calculated image array corresponding to content (e.g., an image or a pattern) to be displayed on a surface of a display device. Each projection may be a conjugate of the respective target relay image in the plurality of target relay images. For example, the projection and the respective target relay image are conjugates of each other with respect to the microlens array.

In an aspect, a total calculated image array is determined based on the calculated image arrays corresponding to the plurality of target relay images. For example, the projections are superimposed by accumulating the calculated image arrays to obtain the total calculated image array.

A display image may be generated on the surface of the display device based on the total calculated image array, for example the display device is configured to display the display image on the screen of the display device. The display image shown on the display device is distinct from the individual calculated image arrays, as the display image represents a cumulative elemental image array synthesized from the projections of all of the plurality of target relay images.

A plurality of relay images (e.g., actual images formed by light beams from the display device) is formed by the microlens array from the display image on the surface of the display device. Each of the plurality of relay images is an optical image corresponding to a respective one of the plurality of target relay images. Based on the reversibility of the optical path, light from the display device passes through the microlens array to reconstruct the relay images at the respective depth positions along the optical axis. A plurality of virtual images is formed by an optical system (e.g., a folded optical system), and each of the plurality of virtual images corresponds to a respective one of the plurality of relay images. The microlens array is disposed between the optical system and the display device.

The light beams emitted from the display image (e.g., the light beams corresponding to the display image) are directed by the microlens array to form the plurality of relay images. Light beams from the plurality of relay images (e.g., light beams corresponding to the plurality of relay images) enter the optical system (shown in FIG. 2) and are folded in the optical system. Thus, the plurality of relay images is magnified by the optical system to form the plurality of virtual images at multiple virtual image planes with virtual image distances that may range, for example, from approximately 0.2 meters to infinity as measured from the eye (e.g., from −5D to 0D).

FIG. 2 shows a display system (200) configured for the 3D display in a side view according to an aspect of the disclosure. The display system (200) includes a display device (220), a microlens array (230) including a two-dimensional array of lenses (also referred to as microlenses) (231) configured to form a plurality of relay images located at respective relay planes (261)-(263) based on light beams from a pattern (e.g., a display image) on the display device (220), and an optical system (e.g., a folded optical system) (210) configured to form a plurality of virtual images located at respective virtual image planes based on the plurality of relay images located at the respective relay planes (261)-(263).

Each of the plurality of virtual images corresponds to a respective one of the plurality of relay images. In the example shown in FIG. 2, one of the plurality of virtual images corresponding to the relay image at the relay plane (262) is located at the virtual image plane (299).

The plurality of relay images are located at different positions along the optical axis (260) of the display system (200). The plurality of virtual images are located at different virtual positions along the optical axis (260) of the display system (200). In an aspect, the display system (200) employs a telecentric design in which chief rays from the plurality of relay images are parallel or substantially parallel to the optical axis (260). By forming the plurality of relay images at different positions along the optical axis (260), the folded optical system (210) may produce virtual images at multiple corresponding depth planes, thereby enabling true 3D display that alleviates the VAC.

The display device (220) can include a pixel array configured to emit light beams and display images. The folded optical system (210) and the microlens array (230) can direct the emitted light beams from the display device (220) to the light receiver (251). In an example, the light receiver (251) is located in an XY plane, and is referred to as an exit pupil of the display system (200). The XY plane includes an X axis and a Y axis that is orthogonal to the X axis. A light receiver or detector, such as an eye (e.g., a pupil) of a user, can be located at the light receiver (251). In an example, a lens in the eye forms an image on a retina of the eye, and thus the eye perceives an image displayed on the display device (220) as a virtual image on a virtual image plane (299) in FIG. 2. The virtual image plane (299) appears at a distance D2 from the light receiver (251) and appears larger than the image displayed on the display device (220). In some examples, the distance D2 is larger, and in some cases much larger, than a distance D1 between the light receiver (251) and the display device (220).

The microlens array (230) is disposed between the folded optical system (210) and the display device (220). The folded optical system (210) includes one or more lenses (e.g., lenses (245)-(247)) including a plurality of surfaces (e.g., S₁ to S₆).

The folded optical system (210) may include any number of lenses, such as a single lens, 2 lenses, 3 lenses, or the like. The one or more lenses may be configured to modify the light beams from the plurality of relay images (e.g., the light beams corresponding to the plurality of relay images) located at the respective relay planes (261)-(263), and direct the modified light beams to a light receiver (251). In some examples, the one or more lenses include diffractive elements (gratings and prisms), refractive elements (lenses), guiding elements (e.g., planar waveguides and/or fibers), and polarizing elements (e.g., polarizers, half-wave plates, quarter-wave plates, polarization rotators, Pancharatnam-Berry Phase lens—PBP-, and the like). The one or more lenses may have an optical axis (260). In an example, each of the one or more lenses has circular symmetry around the optical axis (260).

In an example, referring to FIG. 2, the one or more lenses include the lenses (245)-(247). Each lens may include an optically transparent member having two surfaces. The lens (245) includes an optically transparent member (245′) having the first surface S₁ and the second surface S₂. The lens (246) includes an optically transparent member (246′) having the first surface S₃ and the second surface S₄. The lens (247) includes an optically transparent member (247′) having the first surface S₅ and the second surface S₆. In an example, the lens (245) is a converging lens, the lens (246) is a diverging lens, and the lens (247) is a converging lens.

In an aspect, the folded optical system (210) includes one or more polarization-selective elements. In an example, the one or more polarization-selective elements include a beam splitter (249), a reflective polarizer (248), a quarter waveplate (QWP) (250), and/or the like.

The beam splitter (249) is configured to partially transmit and partially reflect the light beams from the display device (220). In an example, the beam splitter (249) is not attached to any of the one or more lenses. In an example, the beam splitter (249) is disposed over a surface of the plurality of surfaces directly or indirectly (e.g., via a film or a gap). In an example, the beam splitter (249) is attached to one of the plurality of surfaces, such as S₆ of the lens (247).

The reflective polarizer (248) is configured to pass through light having a first linear polarization state and reflect light having a second linear polarization state that is orthogonal to the first linear polarization state. In an example, the reflective polarizer (248) is not attached to any of the one or more lenses. In an example, the reflective polarizer (248) is disposed over a surface of the plurality of surfaces directly or indirectly (e.g., via a film or a gap). In an example, the reflective polarizer (248) is attached to a surface of the plurality of surfaces, such as S₂ of the lens (245).

The quarter waveplate (QWP) (250) is positioned between the beam splitter (249) and the reflective polarizer (248). In an example, the QWP (250) is attached to the reflective polarizer (248). The reflective polarizer (248) is disposed between the QWP (250) and S₂ of the lens (245).

The display system (200) can be a component in an artificial reality system. The artificial reality system can adjust reality in some manner into artificial reality and then present the artificial reality to a user. The artificial reality can include, e.g., a virtual reality (VR), an augmented reality (AR), a mixed reality (MR), a hybrid reality, or some combination and/or derivatives thereof. Artificial reality content may include completely generated content or generated content combined with captured (e.g., real world) content. The artificial reality content may include video, audio, haptic feedback, or some combination thereof, and any of which can be presented in a single channel or in multiple channels (such as stereo video that produces a three-dimensional effect to the user). In some examples, the display system (200) can be applied to playback of live or prerecorded video.

In an embodiment, a “near eye” display system can include an optical system (e.g., including one or more optical elements) that is configured to be placed within the distance threshold of an eye of a user when the display system (200) (e.g., an NED system such as an IMD or smart glasses) is utilized. Referring to FIG. 2, the distance D1 between the display device (220) and the light receiver (251) can be less than or equal to the distance threshold. In an example, the distance D1 is between the display device (220) and an eye.

The display system (200) can be a NED system implemented in various forms, such as an HMD system, smart glasses, a smart phone, and/or the like. In some examples, the artificial reality system is implemented as a standalone NED system. In some examples, the artificial reality system is implemented as a NED system connected to a host computer system, such as a server device, a console device, and the like.

Referring to FIG. 2, an optical cavity is formed between the beam splitter (249) and the reflective polarizer (248). The optical cavity includes optical components (e.g., including the QWP (250) and the lenses (246)-(247)) between the beam splitter (249) and the reflective polarizer (248) and spaces between the adjacent optical components.

Referring to FIG. 2, an optical path of a light ray in a light beam is folded in the optical cavity between the beam splitter (249) and the reflective polarizer (248). Accordingly, the display system (200) can be configured to be positioned within a distance threshold (e.g., 35 millimeters (mm)) of an eye of a user, and the display system (200) can be referred to as a near eye display (NED) system, such as a head mounted display (HMD) system worn by a user.

The display device (220) can include a pixel array. In some examples, the pixel array includes multiple pixels arranged to form a two-dimensional surface. The two-dimensional surface of the display device (220) can be substantially flat or planar, can be curved, or can include a combination of flat and planar panels. The display device (220) can be a display panel. The display device (220) can include any suitable type(s) of display panel(s), such as a liquid crystal display (LCD) panel(s), an organic light emitting diode (OLED) panel(s) such as micro OLED panels, and/or the like. A resolution of the display device (220) can be defined according to pixels in the two dimensions or one of the two dimensions of the two-dimensional surface. Each pixel in the pixel array can generate a light beam. Each light beam can include a bundle of light rays in any suitable direction. For example, a pixel A on the display device (220) emits a light beam including a bundle of light rays in suitable directions. A subset (224) of the light rays in the light beam can be directed by the microlens array (230) to the relay image located at the relay plane (262) and subsequently directed by the folded optical system (210) to the light receiver (251). An angular span of the subset (224) of the light beam can be determined based on an acceptance angle of the microlens array (230), an acceptance angle of the folded optical system (210), and the like. Three light rays (221)-(223) of the subset (224) of the light beam are shown in FIG. 2. The three light rays (221)-(223) can include two rays (221) and (223) and a center ray (also referred to as a chief ray) (222). In an example, the rays (221) and (223) are boundary rays.

In some examples, a light beam is randomly polarized if the light beam includes a rapidly varying succession of different polarization states. A light beam can be polarized, such as linearly polarized (e.g., in a linear polarization state), circularly polarized (e.g., in a circular polarization state), elliptically polarized (e.g., in an elliptical polarization state), or the like. For the linearly polarized light, an electric field vector of the light beam is along a particular line. For the circularly polarized light, an electric field vector of the light beam rotates, e.g., clockwise or counter-clockwise as seen by an observer toward whom the light beam is propagating.

Degree of polarization (DOP) is a quantity that indicates a portion of an electromagnetic wave (e.g., a light beam) that is polarized. A perfectly polarized wave can have a DOP of 100%, and an unpolarized wave can have a DOP of 0%. A partially polarized wave can be represented by a superposition of a polarized component and an unpolarized component, and thus can have a DOP between 0 and 100%. DOP can be calculated as a fraction of a total power that is carried by the polarized component of the wave (e.g., a light beam).

A light beam (e.g., the light beam generated from each pixel) can have any suitable polarization state(s) or DOP. In an example, the light beam is circularly polarized having a DOP of 100%. In an example, the light beam is predominantly circularly polarized having a relatively large DOP that is above a threshold (e.g., 80% or above), such as a superposition of (i) a circularly polarized component and (ii) an unpolarized component and/or another polarization component. A circularly polarized light beam having a DOP of 100% or a predominantly circularly polarized light beam having a relatively large DOP can be referred to as a circularly polarized light beam below. In an example, a light beam is linearly polarized having a DOP of 100% or predominantly linearly polarized having a relatively large DOP that is above a threshold. A linearly polarized light beam having a DOP of 100% or a predominantly linearly polarized light beam having a relatively large DOP can be referred to as a linearly polarized light beam below.

The light beams generated by the display device (220) may be circularly polarized, linearly polarized, or randomly polarized.

In an example, the lens (245) can be referred to as an eye lens according to its proximity to the light receiver (251), and the lens (247) can be referred to as a display lens according to its proximity to the display device (220). The lenses (245)-(247) can be separated by one or more gaps or spaces that are larger than 0. In an example, portions of two adjacent lenses are in contact, for example, the smallest distance between the two adjacent lenses is zero.

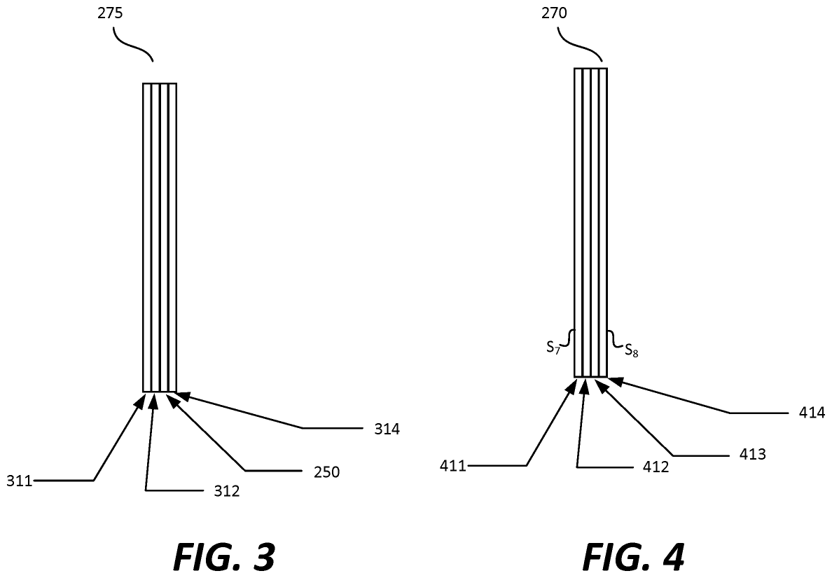

The beam splitter (249) and the reflective polarizer (248) can be disposed between the light receiver (251) and the display device (220). The QWP (250) can be disposed between the beam splitter (249) and the reflective polarizer (248). Anti-reflection (AR) coating(s) (also referred to as AR layers) can be applied to any suitable surface(s) of the optical system (200) to reduce unwanted reflections of the light beams. FIG. 3 shows a multi-layer film (also referred to as a composite film layer) (275) including multiple optical films according to an aspect of the disclosure. The multi-layer film (275) includes an AR layer (314) configured to increase transmittance at the medium surface (e.g., S₂), the QWP (250) configured to convert circularly polarized light to linearly polarized light and to convert linearly polarized light to circularly polarized light, a polarization beam splitter film (312), and a polarizer (311) configured to convert circularly polarized light to linearly polarized light and/or to eliminate stray light. The polarization beam splitter film (312) is configured to reflect the second linear polarization state (e.g., S-polarized light) and transmit the first linear polarization state (e.g., P-polarized light).

In an example, the reflective polarizer (248) includes the polarization beam splitter film (312).

In an example, the reflective polarizer (248) includes the polarization beam splitter film (312) and the polarizer (311), and the multi-layer film (275) including the layers (311)-(312), (250), and (314) is attached to S₂. In this case, the polarizer (311) is attached to S₂.

In an example, referring to FIG. 3, the sequence of the layers is (311), (312), (250), and (314) with (311) being attached to S₂.

The beam splitter (249) can be configured to partially transmit and partially reflect light beams incident onto the beam splitter (249). The beam splitter (249) can have an average optical transmittance T and an average optical reflectance R. In an example, a sum of T and R is 1 (i.e., 100%) over a wavelength range (e.g., 380 to 780 nanometers (nm)). The average optical transmittance T and the average optical reflectance R of the beam splitter (249) can be referred to as T/R. T or R can be in a range (e.g., from 40% to 60%). In an example, the beam splitter (249) has T/R of 40/60, 50/50, or 60/40. For example, if T and R are 50%, the beam splitter (249) transmits 50% and reflects 50% of the light beams incident onto the beam splitter (249). In some examples, a beam splitter can include one or more thin films coated or deposited on a surface of a lens (e.g., the lens (247)) in the folded optical system (210). In an example, the beam splitter (249) is formed on S₆ of the lens (247), and the beam splitter (249) can include one or more thin films coated or deposited on S₆ of the lens (247). The beam splitter (249) partially transmits and partially reflects light beams from the relay images.

In some examples, the display system (200) includes a panel (270). In an example, the panel (270) includes one or more layers such as layers (411)-(414) in FIG. 4. FIG. 4 shows the panel (270) including multiple optical films according to an aspect of the disclosure. The panel (270) includes an AR layer (411) configured to increase transmittance, a QWP (412) configured to convert circularly polarized light to linearly polarized light and to convert linearly polarized light to circularly polarized light, a polarizer (413) configured to convert circularly polarized light, unpolarized light such as natural light, or the like to linearly polarized light, and a QWP (414) configured to reduce stray light. In some examples, the panel (270) includes the AR layer (411), the QWP (412), and the polarizer (413) without the QWP (414).

In an example, referring to FIG. 4, the sequence of the layers is (411), (412), (413), and (414). In another example, the sequence of the layers is (411), (412), and (413).

A polarization state of a light beam can be altered as the light beam passes through certain optical elements. In an embodiment, a polarization state of a light beam can be altered by a waveplate or a retarder as the light beam travels through the waveplate. A QWP alters a polarization state of a light beam traveling through the QWP by 90° or π/2. In an example, the QWP converts linearly polarized light into circularly polarized light or circularly polarized light into linearly polarized light.

The reflective polarizer (248) can be configured to pass through a light beam having the first linear polarization state and reflect the light beam having the second linear polarization state. The second linear polarization state is orthogonal to the first linear polarization state. The reflective polarizer (248) can include one or more layers of optical films.

The beam splitter (249), the QWP (250), and the reflective polarizer (248) may conform to shapes of respective surfaces that are attached by them. Referring to FIG. 2, the beam splitter (249) is curved to conform to a shape of S₆. The QWP (250) and the reflective polarizer (248) are planar to conform to the shape of S₂.

The light beams emitted from the display device (220) are randomly polarized, such as natural light. The light beams are focused by the microlens array (230) to form the plurality of relay images on the relay planes (261)-(263). Further, the polarization states of the light beams are changed from being randomly polarized to a linear polarization state via the polarizer (413) and then from the linear polarization state to a circular polarization state via the QWP (412). Subsequently, the light beams incident onto the beam splitter (249) can be partially transmitted by the beam splitter (249). Subsequently, the light beams pass the optical cavity a plurality of times, as shown in a folded path (225) between the beam splitter (249) and the reflective polarizer (248). In an example, the light beams pass the optical cavity for a first time and are reflected by the reflective polarizer (248). The light beams then pass the optical cavity for a second time and are partially reflected by the beam splitter (249). After passing the optical cavity for a third time, the light beams are transmitted by the reflective polarizer (248) and reach the light receiver (251).

The display system (200) includes a catadioptric optical system. For example, the catadioptric display system (200) includes (i) refractive optical components (e.g., the lenses and the beam splitter (249)) and (ii) reflective optical components (e.g., the beam splitter (249) and the reflective polarizer (248)).

The catadioptric display system (200) may include a polarized catadioptric optical system. For example, each time the light beams pass through a QWP, a polarization state of the light beams is manipulated by the QWP. Accordingly, the light beams are in one polarization state and are reflected by the reflective polarizer (248) after the first pass, and the light beams are in another polarization state and are transmitted by the reflective polarizer (248) after passing the optical cavity for a third time.

The display system (200) may be referred to as a folded system. As light beams are reflected between the beam splitter (249) and the reflective polarizer (248), and travel multiple times (e.g., three times) in the optical cavity, an optical path between the display device (220) and the light receiver (251) includes a folded path (225) between the beam splitter (249) and the reflective polarizer (248). The folding of the optical path can allow the distance D1 to be decreased, and the display system (200) can be used as a NED system. In an example, the folded optical system (210) is designed to have a relatively small thickness D5, and may be referred to as a pancake lens system. In an example, the display system (200) is referred to as a pancake optical system when the distance D1 is relatively small.

Referring to FIG. 2, the ray (222) emitted from the pixel A of the display device (220) is incident onto the lens (231) of the microlens array (230). The ray (222) exiting from the lens (231) is parallel or substantially parallel to the optical axis (260). The ray (222) that is randomly polarized passes through the panel (270) and exits from the panel (270) having a circular polarization (e.g., LCP). The ray (222) with LCP is partially transmitted by the beam splitter (249). Subsequently, the ray (222) passes the optical cavity for a first time where the ray (222) sequentially passes through the lenses (246)-(247) and the QWP (250).

After exiting the QWP (250), the ray (222) with the LCP is converted to the ray (222) with a linear polarization (e.g., S-polarization). After the ray (222) passes the optical cavity for the first time, the ray (222) is reflected back into the optical cavity by the reflective polarizer (248). Subsequently, the ray (222) passes the optical cavity for a second time where the ray (222) sequentially passes through the QWP (250) and the lenses (246)-(247). After the ray (222) passes through the QWP (250), the ray (222) with the S-polarization is converted to the ray (222) with LCP.

After the ray (222) passes the optical cavity for the second time, the ray (222) is partially reflected back into the optical cavity by the beam splitter (249). When the ray (222) is reflected by the beam splitter (249), the polarization state is changed from LCP to RCP. Subsequently, the ray (222) passes the optical cavity for a third time where the ray (222) sequentially passes through the lenses (246)-(247) and the QWP (250). When exiting from the QWP (250), the polarization state of the ray (222) changes from RCP to the P-polarization state, and thus the ray (222) is transmitted by the reflective polarizer (248) and travels to the light receiver (251). In an example, the ray (222) is focused by the lens of the eye onto the retina, and the eye perceives the ray (222) as if the ray (222) is from the virtual point A″ on the virtual image plane (299).

According to an embodiment of the disclosure, the light beams emitted from the pixels (e.g., including the pixel A) in the display device (220) can be randomly polarized and the polarization state of the light beams changes from being randomly polarized to the first circular polarization state by the combined operation of the polarizer (413) and the QWP (412). The beam splitter (249) partially transmits the ray (222) in the first circular polarization state. Then the ray (222) passes the optical cavity for the first time as described above. During the first pass, the first circular polarization state of the ray (222) is converted to the second linear polarization state by the QWP (250). The second linear polarization state is along a block direction of the reflective polarizer (248). The block direction of the reflective polarizer (248) refers to a direction where if an electric field vector of a light beam is along the block direction, the light beam is blocked by the reflective polarizer (248) and is not transmitted through the reflective polarizer (248). The reflective polarizer (248) reflects the ray (222) having the second linear polarization state, for example, with a relatively high average reflectance that is above or equal to a value (e.g., 90%) over a wavelength range (e.g., 380 to 780 nm). Then the ray (222) passes the optical cavity for the second time as described above, and the ray (222) is partially reflected by the beam splitter (249). Subsequently, the ray (222) passes the optical cavity for the third time as described above. During both the second pass and the third pass, the second linear polarization state of the ray (222) is converted to the first linear polarization state that is parallel to a transmission direction of the reflective polarizer (248). Thus, the reflective polarizer (248) transmits the ray (222) having the first linear polarization state such that the ray (222) is directed to the light receiver (251) with a relatively high transmittance that is above or equal to a value (e.g., 90%) over a wavelength range (e.g., 380 to 780 nm).

Referring to FIG. 2, the optical path includes the folded path (225) between the reflective polarizer (248) and the beam splitter (249) due to the polarization change. In an example, the QWP (250) has two axes (e.g., a fast axis and a slow axis) that are in the XY plane. One of the two axes of the QWP (250) is oriented at 450 to an axis of the reflective polarizer (248).

To achieve high quality imaging, the reflective polarizer (248) is to have high-quality, such as a high reflectance (e.g., the high average reflectance) in the block direction, a high transmittance (e.g., the high average transmittance) in the pass direction, relatively small surface roughness, and the like. Further, the AR coating can be applied to any suitable surface(s) in the optical system (200) to reduce or eliminate ghosting due to the multi-reflections at various interfaces.

Referring to FIG. 2, the panel (270) may be positioned between the beam splitter (249) and the display device (220). The panel (270) may be attached to another optical component, such as a surface of the other optical component, or may be separated from other optical components as shown in FIG. 2. Referring to FIGS. 2 and 4, S₇ is a surface of the layer (411), and S₈ is a surface of the layer (414).

In an aspect, unlike Pancake optical systems in related technologies, the display system (200) employs a telecentric design in which chief rays (222) and (271)-(273) from the plurality of relay images positioned at the respective relay planes (261)-(263) are incident on the respective relay planes (261)-(263) at zero degrees or substantially zero degrees with respect to the optical axis (260). For example, the chief rays (222) and (271)-(273) are perpendicular or substantially perpendicular to the relay planes (261)-(263).

Referring to FIG. 2, pixels A-D on the display device (220) are located on different positions along the Y axis, e.g., D is on the optical axis (260), and A-C are located away from the optical axis (260). The center rays from A-D are the rays (222), (272), (273), and (271). The center rays (222) and (271)-(273) are perpendicular or substantially perpendicular to the display device (220), and thus have a zero-degree emission angle (e.g., an angle between the center rays and a line that is perpendicular to the display device (220) is 00). The center rays (222) and (271)-(273) are directed to form the plurality of relay images, and are also perpendicular or substantially perpendicular to the relay planes (261)-(263).

In an embodiment, the telecentric design is achieved by positioning a pupil of the folded optical system (210), which serves as an aperture stop of the folded optical system (210), at a first side focal plane of the folded optical system (210). Referring to FIG. 2, the light receiver (251) is placed at the pupil of the folded optical system (210), which is located at the first side focal plane of the folded optical system (210). Thus, parallel or substantially parallel rays from the plurality of relay images positioned at the respective relay planes (261)-(263) are focused on a position of the light receiver (251). When the rays (e.g., the chief rays) from the plurality of relay images positioned at the respective relay planes (261)-(263) are parallel or substantially parallel to the optical axis (260), the rays are focused on a center (281) of the light receiver (251). The center (281) is an intersect of the optical axis (260) and the light receiver (251).

Based on the reversibility of the optical path, by positioning the aperture stop at the first side focal plane, rays emitted from each point of the pupil travel substantially parallel to one another when reaching the relay planes (261)-(263), and the chief ray from the center (281) of the pupil is perpendicularly incident on the relay planes (261)-(263). Thus, in some examples, the first side focal plane is referred to as an object-side focal plane.

The telecentric design provides several advantages. First, the telecentric design enables the light field module (e.g., the display system (200) including the microlens array (230)) to utilize paraxial ray imaging, thereby reducing imaging distortion. In an example, paraxial rays whose angles with respect to the optical axis (260) are less than a threshold are used in the paraxial ray imaging. In the paraxial ray imaging, Snell's Law is simplified to a linear approximation. Second, the telecentric design takes advantage of the angular emission characteristics of display pixels in the display device (220), which exhibit relatively large luminance at a zero-degree emission angle, thereby improving overall imaging brightness.

One or more of the surfaces such as S₁ to S₁₁ in the display system (200) may have any suitable shape(s), such as a planar shape parallel to the XY plane, a spheric shape with any suitable radius of curvature, an aspheric shape, or another shape. Optical parameters of the display system (200) may have any suitable values. In an aspect, the specific shapes of the surfaces and the specific values of the optical parameters are determined by requirements for the display system (200) including, for example, the telecentric design, the field of view (FOV), and the like.

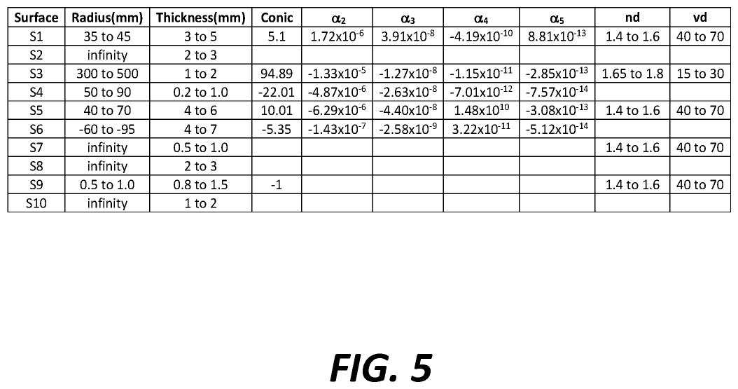

FIG. 5 shows some examples of optical parameters of the display system (200) according to an aspect of the disclosure. S₁ and S₃ to S₆ are even-order aspheric surfaces. Each convex surface S₉ of the lenses (231) in the microlens array (230) is an even-order aspheric surface. The even-order aspheric surface formula for S (S is one of S₁ and S₃ to S₆) is described in Eq. 1.

$$S = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad Eq . 1$$

In an aspect, the parameter c is 1/Radius, k is the conic parameter, nd is the refractive index, and vd is the Abbe number. In some examples, α₁=0, α₆=0, α₇=0, and α₈=0.

Referring to FIG. 5, a radius of S₁ is in a range of 35 to 45 mm, S₂ is planar, and a thickness of the lens (245) ranges from 3 to 5 mm. A gap between the lenses (245)-(246) ranges from 2 to 3 mm.

In an example, a radius of S₃ is in a range of 300 to 500 mm, a radius of S₄ is in a range of 50 to 90 mm, and a thickness of the lens (246) ranges from 1 to 2 mm. A gap between the lenses (246)-(247) ranges from 0.2 to 1 mm.

In an example, a radius of S₅ is in a range of 40 to 70 mm, a radius of S₆ is in a range of −60 to −95 mm, and a thickness of the lens (247) ranges from 4 to 6 mm. A gap between the lens (247) and the panel (270) ranges from 4 to 7 mm.

In an example, the surfaces S₇-S₈ of the panel (270) are flat. A thickness of the panel (270) ranges from 0.5 to 1 mm.

In an example, a gap between the panel (270) and the microlens array (230) ranges from 2 to 3 mm.

In an example, a radius of each lens (231) ranges from 0.5 to 1 mm, and a thickness of each lens (231) ranges from 0.8 to 1.5 mm. A gap between the microlens array (230) and the display device (220) ranges from 1 to 2 mm. In an example, the surface S₁₁ of the display device (220) is flat.

The optical components in the display system (200), including, for example, the optically transparent members (245′) to (247′), the panel (270), and the microlens array (230), and the like may include any suitable material(s), such as glass, polymer, plastic material(s), or the like. In an example, the optically transparent members (245′) to (247′), the panel (270), and the microlens array (230), and the like include optical resins, poly(methyl methacrylate) (PMMA), polyimide, acrylic, styrene, cyclic olefin polymer, cyclic olefin co-polymer, polycarbonate, and/or the like.

In some examples, a glass lens may be fabricated by grinding and polishing, a glass molding method, and/or the like. A polymer or plastic lens may be fabricated by diamond turning, polishing, injection molding, casting, and/or the like.

In an example, the panel (270) and the microlens array (230) include glass, optical resin, and/or the like. In the example shown in FIG. 2, the panel (270) and the microlens array (230) include glass.

In an example, the folded optical system (210) has an effective focal length (EFL) of approximately 23.1 mm, a field of view (FOV) of approximately 60 degrees, and an overall thickness (e.g., a distance between S₁ and S₁₁) of approximately 26.5 mm. In an example, the display device (220) includes a micro OLED screen having a diagonal size of approximately 1.3 inches and a resolution of 3840×3552 pixels. In an example, the display device (220) includes a liquid crystal display (LCD) screen, with a diagonal size ranging from approximately 0.8 inches to approximately 1.5 inches and a resolution greater than 2K.

A resolution of an optical system can indicate an ability of the optical system to distinguish object detail. In an example, the resolution is expressed in terms of line-pairs per millimeter (lp/mm) where a line-pair is a sequence of one black line and one white line.

A contrast or a modulation of an image can be defined as contrast (%)=(Iₘₐₓ−Iₘᵢₙ)/(Iₘₐₓ+Iₘᵢₙ) where Iₘₐₓ and Iₘᵢₙ represent a maximal intensity and a minimal intensity of the image, respectively.

One parameter that indicates the performance of an optical system is a modulation transfer function (MTF). The MTF of the optical system can indicate an ability of the optical system to transfer a contrast at a particular resolution from an object to an image of the object. In an example, the MTF incorporates the resolution and the contrast into a single parameter. As line spacing decreases (e.g., the resolution increases), it becomes increasingly difficult for the optical system to efficiently transfer the decrease in contrast. Thus, the MTF decreases.

Sagittal lines used in determining an MTF can refer to lines radiating from a center to an image circle periphery. Tangential (or meridional) lines are perpendicular to the sagittal lines. Because an optical system may not focus lines of both directions equally on a same plane, sagittal and tangential measurements for the same optical system can differ. An MTF can be a sagittal MTF if the sagittal lines are used to determine the MTF or a tangential MTF if the tangential lines are used to determine the MTF.

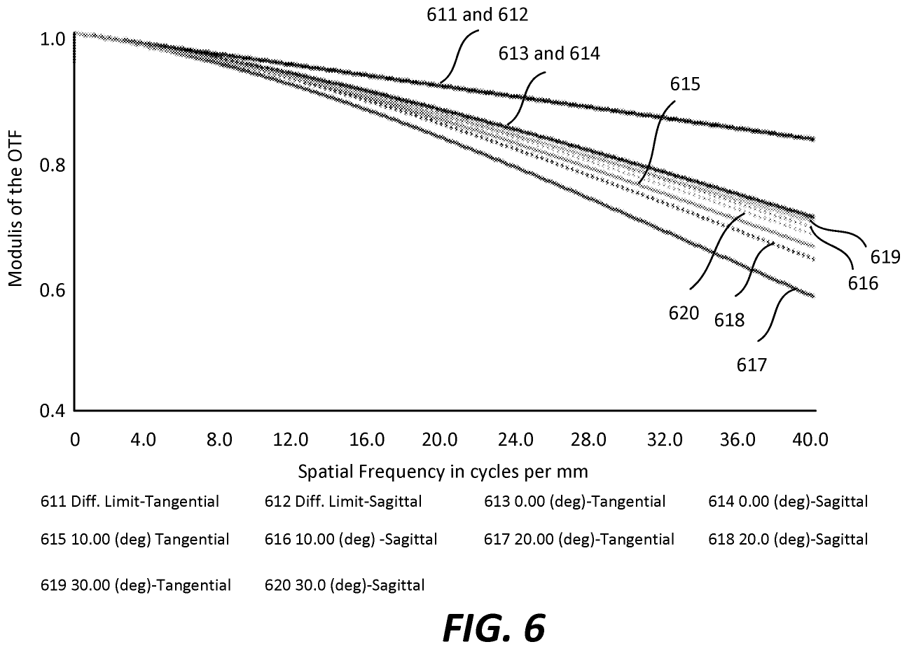

FIG. 6 shows MTFs of the display system (200) according to an aspect of the disclosure. FIG. 6 shows sagittal (dashed lines) and tangential (solid lines) MTFs versus a spatial frequency (in cycles per mm). The sagittal MTFs (612), (614), (616), (618), and (620) and the tangential MTFs (611), (613), (615), (617), and (619) correspond to a diffraction limit, and field angles of 0°, 10°, 20°, and 30°, respectively. In an example, the sagittal MTF (612) and the tangential MTF (611) correspond to the diffraction limit where the performance of the display system (200) is limited by the physical effects of diffraction rather than imperfections, including, for example, imperfections in the design, fabrication, and/or the like. The diffraction limited curves (611)-(612) correspond to the aberration free responses at the reference field position. In optical system design, MTF curves (e.g., one or more of (613)-(620)) that are closer to the diffraction limit curves (611)-(612) may indicate improved optical performance. As shown in FIG. 6, the display system (200) achieves high imaging quality at the relay image planes. In simulation of the relay image plane imaging quality, at a spatial frequency of 40 lp/mm, the MTF values for red, green, and blue (RGB) relay images can be greater than 0.5, indicating clear imaging performance.

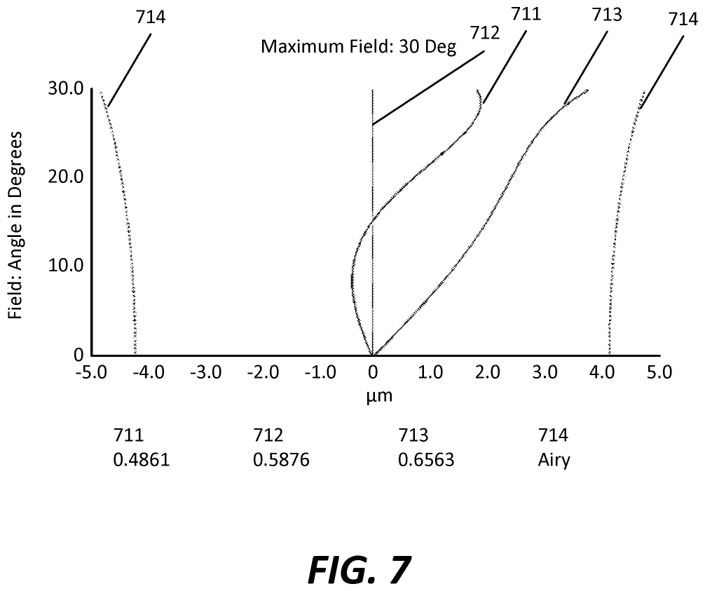

In some examples, the lateral chromatic aberration is measured as the transverse displacement of different colors (wavelengths) in the image plane, for example, by comparing the positions of red and blue channels relative to a reference green channel. In some examples, the transverse displacement of different colors (wavelengths) in the image plane is also referred to as the lateral displacement or “blur” caused by chromatic aberration. FIG. 7 shows the curves (711)-(714). The vertical axis indicates a field angle (e.g., from 0° to 30° which corresponds to the FOV of 60°), and the horizontal axis indicates a transverse displacement (e.g., in micrometers). The curves (711)-(713) correspond to the blue channel with a wavelength of 486.1 nm, the green channel with a wavelength of 587.6 nm, and the red channel with a wavelength of 656.3 nm. In an example, the curve (714) corresponds to an Airy disk radius. In an aspect, the Airy disk is a central bright spot of a diffraction pattern produced by a circular aperture. The Airy disk radius depends on a wavelength and a f-number (e.g., a focal length divided by the aperture diameter of the circular aperture) of the optical system. In various examples, when the transverse displacement caused by the chromatic aberration is smaller than the Airy disk as indicated by the Airy disk radius, a light receiver such as a human eye may not distinguish the chromatic aberration from the diffraction limit and thus the chromatic aberration of the optical system is considered as corrected. In an example shown in FIG. 7, the Airy disk radius at the primary wavelength (e.g., the wavelength of 587.6 nm) is about 4 microns (e.g., between 4 and 4.5 microns as shown in FIG. 7). Referring to FIG. 7, the chromatic aberration of the optical system indicated by the curves (711)-(713) lies within the Airy disk, indicating that the chromatic aberration of the optical system is corrected. With respect to lateral chromatic aberration, the RGB chromatic aberration shown in FIG. 7 at the maximum field of the display system (200) is less than 4 micrometers. In an example, this can meet the requirement of being smaller than a single pixel size, such that chromatic aberration is visually imperceptible and does not require post-processing software correction.

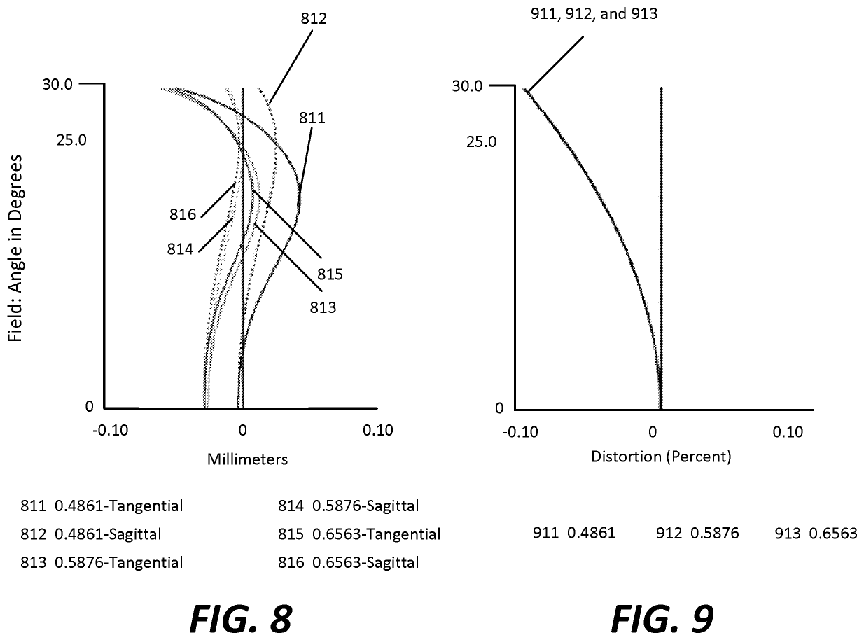

A field curvature indicates how focus shifts across the field due to a curved image surface. A field curvature plot may indicate that an image surface is curved rather than flat. FIG. 8 shows an example of field curvature plots (811)-(816) for the display system (200) according to an aspect of the disclosure. The vertical axis indicates a field angle (e.g., from 0° to 30° which corresponds to the FOV of 60°), and the horizontal axis indicates a shift of the focus (e.g., in mm). The field curvature plots (811), (813), and (815) are tangential (T) focus lines, and correspond to a first wavelength (e.g., 486.1 nm), a second wavelength (e.g., 587.6 nm), and a third wavelength (e.g., 656.3 nm), respectively. The field curvature plots (812), (814), and (816) are sagittal (S) focus lines, and correspond to the first wavelength (e.g., 486.1 nm), the second wavelength (e.g., 587.6 nm), and the third wavelength (e.g., 656.3 nm), respectively.

In some examples, an average of T and S represents the curved image surface (field curvature). For example, an average of (811) and (812) represents the curved image surface (field curvature) for the first wavelength. In some examples, a separation between T and S indicates astigmatism. For example, the separation between (811) and (812) represents the astigmatism for the first wavelength. Design goals may include bringing T and S as close together as possible and near the intended image plane (often a flat display mapped to a virtual plane).

Referring to FIG. 8, for a fixed imaging plane, the maximum field curvature of the display system (200) is less than 0.08 mm, and thus uniformity of imaging clarity is maintained across the field of view.

A distortion may indicate how the magnification in an image changes across the FOV, for example, at a fixed working distance. Plots may indicate a relative distortion (%) versus the field angle. FIG. 9 shows an example of distortion plots (911)-(913) for the display system (200) according to an aspect of the disclosure. The vertical axis indicates a field angle (e.g., from 0° to 30°), and the horizontal axis indicates the distortion (e.g., in %). The distortion plots (911)-(913) are tangential plots. The plots (911)-(913) indicate that the distortions among different wavelengths are similar. Referring to FIG. 9, the optical distortion at the maximum field is approximately 9%. This level of distortion can be readily corrected through post-processing software.

In an aspect, to form a true 3D display, for example, using the display system (200), a 3D target object to be displayed is divided into a set of 2D objects that are located at different positions on the optical axis (260). In order to display the set of 2D objects at the different positions on the optical axis (260) on a screen of the display device (220) that is located at a single position on the optical axis (260), light field sampling and reconstruction may be used.

In some examples, each 2D object includes a target relay image positioned at a respective plane such as one of the relay planes (261)-(263)) in 3D space. In the sampling process, a simulation (e.g., a calculation) is performed where the plurality of target relay images positioned at the different planes (e.g., the relay planes (261)-(263)) in 3D space are treated as target objects that emit light rays. Each of the plurality of target relay images is a set of mathematical intensity values representing a desired optical image to be formed by the microlens array (230), rather than a physically formed image.

In the simulation, each target relay image at the respective position on the optical axis (260) is computationally projected onto a surface (e.g., a plane) corresponding to the surface of the display device (220) by a simulated microlens array having similar or identical optical parameters as those of the microlens array (230).

The light rays from the set of 2D objects (e.g., the plurality of target relay images) positioned at the different planes (e.g., the relay planes (261)-(263)) in 3D space pass through the simulated microlens array and are recorded as the set of projections onto the surface where the display device (220) is located. Each projection is a calculated image array (also referred to as an elemental image array) that contributes to content to be displayed on the display device (220). As described above, the plurality of target relay images are treated as the target objects that emit light rays, and thus the projection is referred to as an image array or an elemental image array.

In an aspect, each computational projection (e.g., an elemental image array projected to the surface of the display device (220)) is a conjugate of the respective target relay image in the plurality of target relay images, and each target relay image is a conjugate of the respective computational projection due to the optical reversibility.

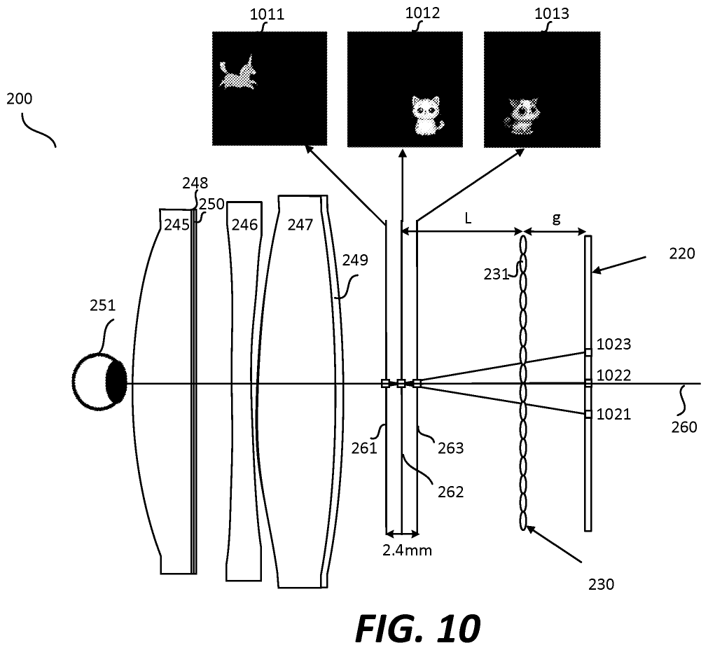

Referring to FIG. 10, the lenses (245)-(247), the microlens array (230), and the display device (220) of the display system (200) are redrawn. In the calculating step, the plurality of target relay images such as 2D images (1011)-(1013) from multiple depth planes are used as input. The multiple depth planes include the relay images (261)-(263). The 2D images (1011)-(1013) are located at the multiple depth planes (261)-(263), respectively.

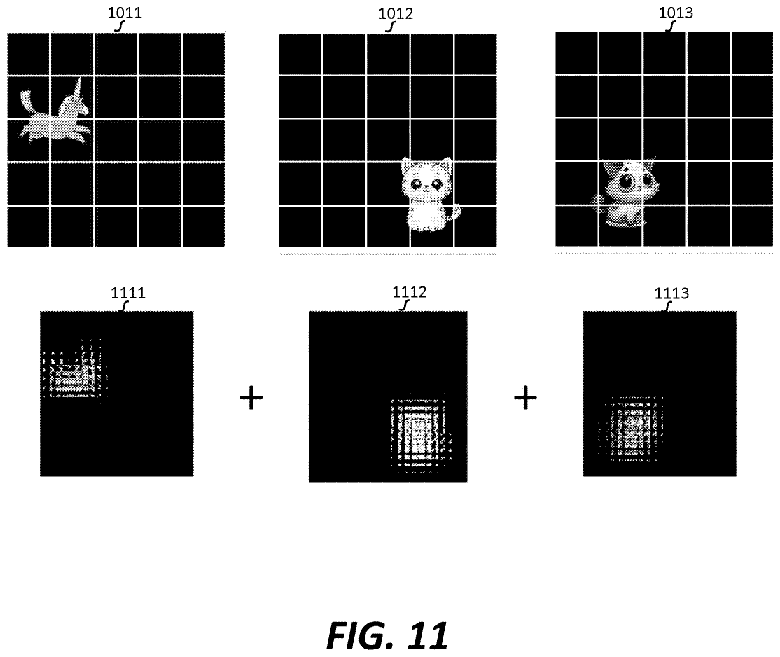

In some examples, each 2D image at a given depth plane is divided into image units corresponding to individual microlenses in the microlens array (230). In an example, a number of the image units is equal to a number of microlenses in the microlens array (230). Each of the 2D images (1011)-(1013) is divided into multiple image units. FIG. 11 shows a portion of each 2D image that includes 5×5 image units.

Each image unit is then projected by the corresponding microlens onto the surface of the display device (220), and by traversing all microlenses, the projection (e.g., the elemental image array) of the entire 2D image (e.g., the 2D image (1011)) for the respective depth plane (e.g., the relay plane (261)) onto the surface of the display device (220) is obtained. In an aspect, an elemental image refers to the projection of a corresponding image unit by the microlens array (230). For example, the elemental images collectively form the elemental image array (1111) after the image units in the 2D image (1011) are projected through the microlens array (230). Referring to FIG. 11, in an example, the projection (1111) of the entire 2D image (1011) for the relay plane (261) onto the surface of the display device (220) is obtained. The projection (1112) of the entire 2D image (1012) for the relay plane (262) onto the surface of the display device (220) is obtained. The projection (1113) of the entire 2D image (1013) for the relay plane (263) onto the surface of the display device (220) is obtained. Thus, the set of elemental image arrays (1111)-(1113) from different viewpoints are obtained.

The elemental images collectively form an elemental image array.

In some examples, the projections (1111)-(1113) from all depth planes are then superimposed. The image array pixels of the respective projections (1111)-(1113) from each depth plane are accumulated to produce the total elemental image array. The total elemental image array includes the content (e.g., the image) to be displayed on the display device (220). In an embodiment, the accumulation is expressed as Eq. 2.

$$EIA\_total = EIA\_total + EIA\_temp \qquad Eq . 2$$

EIA temp represents the image array (e.g., (1111), (1112), or (1113)) computed for each individual depth plane, and EIA_total represents the cumulative elemental image array. In an example, Eq. 2 is implemented iteratively, and the final EIA_total is the total elemental image array. Referring to FIG. 11, in a first step, EIA_total is the same as the projection (1111). In a second step, a current EIA_total is a superposition of the previous EIA_total (e.g., the projection (1111)) obtained in the first step and the projection (1112). In a third step, a current EIA_total is a superposition of the previous EIA_total obtained in the second step and the projection (1113). In this example, the current EIA_total obtained in the third step is the total elemental image array.

In some examples, each elemental image array has the same size. In an example, the elemental image arrays have the same pixel dimensions, and Eq. 2 is applied on a per-pixel basis.

In an example as described below, the resolution of the respective 2D image (e.g., the reconstructed image) at each depth plane differs, and the reconstructed images are resampled or generated at the respective resolutions before projection.

In some examples, the set of elemental image arrays (1111)-(1113) is centered before applying Eq. 2 to prevent spatial misalignment and overlap artifacts among the elemental image arrays (1111)-(1113) of different depth planes.

In some examples, each elemental image array has grayscale values in each of multiple channels. For example, the multiple channels include the RGB three-channels, and each elemental image array has the RGB three-channel grayscale values. In an example, Eq. 2 is applied across all three color channels (R, G, B) independently, for example, summing the grayscale intensity values channel by channel.

Thus, light rays from the target objects in 3D space pass through the microlens array and are recorded, and a set of elemental images is obtained from different viewpoints and the elemental image array is formed.

Referring back to FIG. 10, g is the distance between the microlens array (230) and the display device (220) (e.g., a micro display), and L is the distance between the relay plane (also referred to as the reconstruction depth plane) (e.g., one of the relay planes (261)-(263)) and the microlens array (230). L is also referred to as the light field reconstruction depth.

W is the aperture size of each microlens (231), P is the pixel size on the display device (220), such as the pixel size of the micro display, h is the horizontal pixel count or a number of pixels in the horizontal direction of the display screen of the display device (220), and v is the vertical pixel count or a number of pixels in the vertical direction of the display screen of the display device (220). A number of horizontal microlenses kₓ is h×P/W, a number of vertical microlenses k_{y} is v×P/W, a magnification of the microlens array M is L/g, a reconstructed pixel size P is M×P, and a resolution of each elemental image is A×A, A is W/P, a number of pixel displacements (denoted as “a”) between elemental images is W/P′, and a maximum resolution x′×y′ of the reconstructed image is as below where x′=A+a*(kₓ−1), and y′=A+a*(k_{y}−1). The reconstructed image refers to one of the target relay image, such as the relay image located at the relay plane (261).

The maximum resolution x′×y′ of the reconstructed image depends on the parameter “a” which is W/P′, and P is M×P, and thus the maximum resolution x′×y′ depends on M which is L/g. Referring to FIG. 10, the distance L changes with each reconstructed image (e.g., each relay image at a respective relay plane). Thus, the maximum resolution x′×y′ of the reconstructed image is different for different reconstructed images (or different relay images). Referring to FIG. 10, the plurality of target relay images such as the 2D images (1011)-(1013) from the multiple depth planes have different maximum resolutions x′×y′. Each of the 2D images (1011)-(1013) shows the content intended for the particular depth plane. In an example, non-display content is filled with black or a constant value.

In the reconstruction process, based on the reversibility of the optical path, when the elemental image array (e.g., EIA_total obtained in the third step as described above) is displayed on the display panel of the display device (220), light rays pass through the microlens array (230) to reconstruct the light field distribution of the 3D target object.

In an example, the positions of the relay images along the optical axis (260), e.g., the positions of the relay planes (261)-(263) determine the virtual image distances perceived by the viewer.

In an embodiment, the virtual image distance depends on the respective light field reconstruction depth. In an example, the focal length f of the folded optical system (210) is 23.1 mm. Referring to FIG. 2, the virtual image distance D2 is measured with respect to the position of the light receiver (251). The position of the light receiver (251) is also at the image-side principal plane of the folded optical system (210). To form a virtual image with D2 from 0.2 m to infinity, an object distance is determined based on Eq. 3.

$$\frac{1}{\frac{1}{f} + \frac{1}{l}} = {l}^{′} \qquad Eq . 3$$

In Eq. 3, I refers to the virtual image distance D2, f is the focal length, and I′ is the object distance. A range of object distance is determined based on the range of the virtual image distance D2 and Eq. 3. For example, when the range of the virtual image distance D2 is 0.2 m to 5.31 m, the range of the object distance is from 20.7 to 23.1 mm, and thus the range is 2.4 mm as indicated in FIG. 10. The object distance is measured with respect to an object-side principal plane of the folded optical system (210). In an example, the object distance corresponds to the respective light field reconstruction depth which is also measured with respect to the object-side principal plane of the folded optical system (210).

Referring to FIG. 10, the location of the relay plane (263) corresponds to the reconstruction depth of 23.1 mm, and the location of the relay plane (261) corresponds to the reconstruction depth of 20.7 mm. Table 1 shows a relationship between the light field reconstruction depth and the virtual image distance.

TABLE 1
Relationship between the light field reconstruction
depth and the virtual image distance

| Light Field | |
|---|---|
| Reconstruction | Virtual Image |
| Depth (mm) | Distance (m) |
| 23.1 | −5.31 |
| 22.6 | −1.04 |
| 22.3 | −0.64 |
| 21.9 | −0.42 |
| 21.3 | −0.27 |
| 20.7 | −0.2 |

Different pixel combinations on the display device (220) generate relay images at different reconstruction depth planes. By controlling which pixels contribute to each relay image, the display system (200) may simultaneously produce relay images at multiple depth positions. Referring to FIG. 10, a first pixel combination including pixels (1021)-(1023) on the display device (220) generates the relay image that is located at the relay plane (262). A second combination of pixels contributes to the relay image that is located at the relay plane (261). A third combination of pixels contributes to the relay image that is located at the relay plane (263).

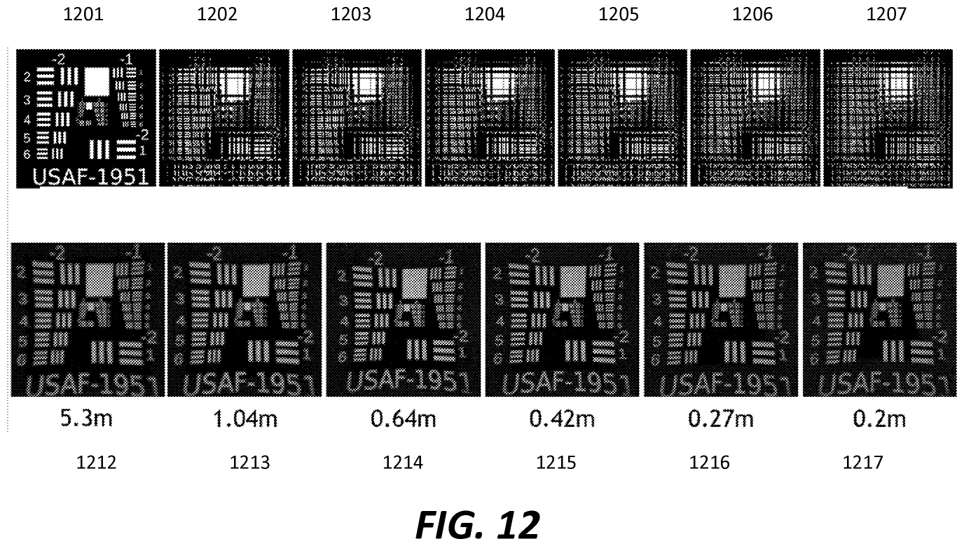

FIG. 12 shows an example of light field display simulation according to an aspect of the disclosure. In this simulation, a number of the target relay images is 6. The 6 target relay images are used to simulate a 3D object. The 3D object includes an image (1201) that is located at 6 different positions (e.g., 6 different depths) along the optical axis. The pattern of the image (1201) is the USAF-1951 standard resolution test chart. Through elemental image array projection of the 2D images from six depth planes, projections (1202)-(1207) from all six depth planes were obtained. The projections (1202)-(1207) were superimposed to obtain the cumulative elemental image array. In optical simulation software, the elemental image array based on the projections (1202)-(1207) is displayed on a micro OLED display. At the eye position (e.g., (251) in FIG. 2), the light field display effect can be obtained. Individual images (1212)-(1217) for each depth plane were captured, and correspond to virtual image distances at 5.3 m, 1.04 m, 0.64 m, 0.42 m, 0.27 m, and 0.2 m, respectively. The overall display effect shown in the images (1212)-(1217) is relatively clear and matches the design objectives. This simulation indicates the feasibility of the optical reconstruction process for the disclosed light field display system.

The display system (200) can have any suitable parameters, such as the FOV, the overall distance between S₁ to S₁₁, distances between adjacent optical components, sizes of the optical components, shapes of surfaces of the optical components, materials of the optical components, and the like. Certain parameter(s) of the display system (200) can be related.

In some examples, the display system (200) includes other components, such as a controller that is configured to control the operations of the display system (200), perform the simulation, and the like. The display system (200) can include other suitable mechanical, electrical and optical components. For example, the display system (200) includes a frame that can protect other components of the display system (200). In another example, the display system (200) can include a strap to fit the display system (200) on a user's head. In another example, the display system (200) can include communication components (not shown, e.g., communication software and hardware) to wirelessly communicate with a network, a host device, and/or other device. In some examples, the display system (200) can include a light combiner that can combine the virtual content and see-through real environment.

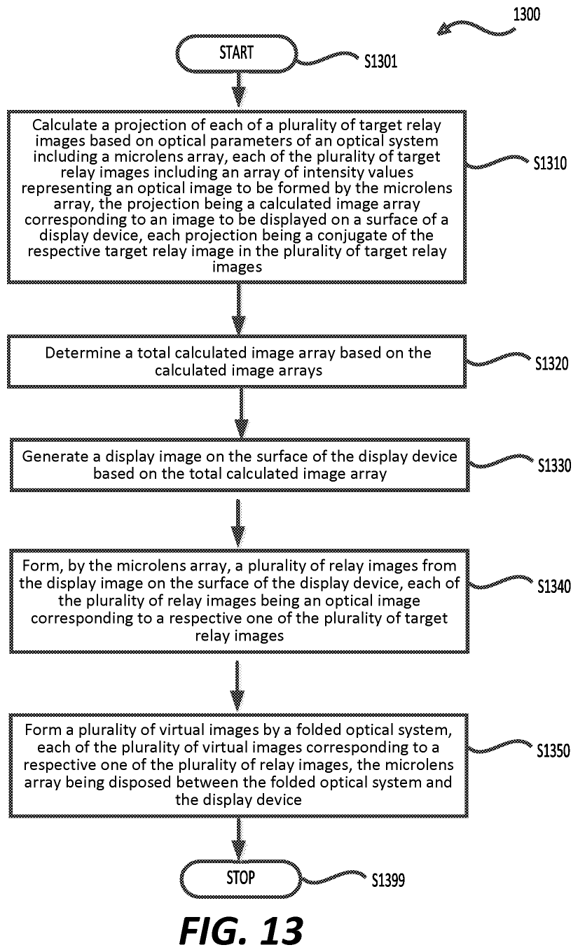

FIG. 13 shows a flow chart outlining a process (1300) according to an aspect of the disclosure. In various aspects, the process (1300) is executed by processing circuitry. The process starts at (S1301) and proceeds to (S1310).

At (S1310), a projection of each of a plurality of target relay images is calculated based on optical parameters of a display system including a microlens array. Each of the plurality of target relay images includes an array of intensity values representing an optical image to be formed by the microlens array. The projection is a calculated image array corresponding to an image to be displayed on a surface of a display device, and each projection is a conjugate of the respective target relay image in the plurality of target relay images.

At (S1320), a total calculated image array is determined based on the calculated image arrays.

At (S1330), a display image is generated on the surface of the display device based on the total calculated image array.

At (S1340), a plurality of relay images is formed from the display image on the surface of the display device by the microlens array. Each of the plurality of relay images is an optical image corresponding to a respective one of the plurality of target relay images.

At (S1350), a plurality of virtual images is formed by a folded optical system.

Each of the plurality of virtual images corresponds to a respective one of the plurality of relay images. The microlens array is disposed between the folded optical system and the display device.

Then, the process proceeds to (S1399) and terminates.

The process (1300) may be suitably adapted. Step(s) in the process (1300) may be modified and/or omitted. Additional step(s) may be added. Any suitable order of implementation may be used.

A folded optical system (or a Pancake optical system) design for light field display is described. Unlike Pancake single-focal-plane imaging structures in related technologies, the folded optical system, through telecentric optical path design and multiple relay images design, simultaneously achieves light field display effects at multiple (e.g., six) depth planes along the optical axis, and thus alleviating the VAC problem.

Based on the designed Pancake light field display architecture, a calculation method for relay images is described, along with the mapping relationship between relay images and light field module display pixels, which can be more broadly applied to optical architectures with different design parameters.

Imaging simulation was performed for the designed light field system, and elemental image arrays from six depth planes were applied to obtain light field display images at the eye position. This indicates the feasibility of the optical reconstruction process.

Embodiments in the disclosure may be used separately or combined in any order.

While this disclosure has described several example embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A display system configured for three-dimensional (3D) display, comprising:
a microlens array including a two-dimensional array of lenses configured to form a plurality of relay images based on light beams from a display device that correspond to an image, and
an optical system configured to form a plurality of virtual images, each of the plurality of virtual images corresponding to a respective one of the plurality of relay images, the microlens array being disposed between the optical system and the display device, the optical system including:
one or more lenses including a plurality of surfaces, and
one or more polarization-selective elements,
wherein
the plurality of relay images are located at different positions along an optical axis of the display system; and
the plurality of virtual images are located at different virtual positions along the optical axis of the display system.

2. The display system according to claim 1, wherein
light beams corresponding to the plurality of relay images are directed to a light receiver by the optical system,
the optical system has a first focal plane on a side of the light receiver and a second focal plane on a side of the plurality of relay images, and
the light receiver is located at the first focal plane of the optical system, chief rays from one of the plurality of relay images are substantially parallel to the optical axis, and the chief rays arrive at an intersect of the light receiver and the optical axis.

3. The display system according to claim 1, wherein
the one or more polarization-selective elements include:
a film including a reflective polarizer configured to pass through light having a first linear polarization state and reflect light having a second linear polarization state that is orthogonal to the first linear polarization state, the reflective polarizer being disposed over a first surface of the plurality of surfaces,
a beam splitter configured to partially transmit and partially reflect the light beams from the display device, the beam splitter being disposed over a second surface of the plurality of surfaces, and
a first quarter waveplate (QWP) that is positioned between the beam splitter and the reflective polarizer,
the one or more lenses include a first lens and at least one second lens that is between the first lens and the microlens array,
the first surface is on the first lens and faces the at least one second lens, the second surface is on the at least one second lens, and
the display system includes the display device, a pixel array in the display device being configured to emit the light beams that correspond to the image.

4. The display system according to claim 3, wherein
an optical cavity is formed between the beam splitter and the reflective polarizer,
the optical cavity includes the at least one second lens and a gap between the first lens and the at least one second lens,
the beam splitter partially transmits one of the light beams having a first circular polarization state,
after the one of the light beams passes the optical cavity for a first time, the first circular polarization state of the one of the light beams is converted to the second linear polarization state by the first QWP,
the reflective polarizer reflects the one of the light beams having the second linear polarization state,
after the one of the light beams passes the optical cavity for a second time, the one of the light beams is reflected by the beam splitter and the one of the light beams has a second circular polarization state,
after the one of the light beams having the second circular polarization state passes the optical cavity for a third time, the second circular polarization state of the one of the light beams is converted to the first linear polarization state by the first QWP, and
the reflective polarizer transmits the one of the light beams having the first linear polarization state such that the one of the light beams is directed to a light receiver.

5. The display system according to claim 4, wherein
the film further includes the first QWP, and
the first QWP is attached to the reflective polarizer, and the reflective polarizer is disposed between the first surface and the first QWP.

6. The display system according to claim 5, wherein
the film further includes a polarizer and an anti-reflection film,
the polarizer is attached to the first surface, and
the first QWP is disposed between the reflective polarizer and the anti-reflection film.

7. The display system according to claim 4, wherein the display system includes a panel that includes:
a polarizer configured to convert the light beams from the display device to the linearly polarized light beams,
a second QWP configured to convert the linearly polarized light beams to the light beams having the first circular polarization state, and
an anti-reflection film, the panel being disposed between the display device and the beam splitter.

8. The display system according to claim 4, wherein
the at least one second lens includes a second lens and a third lens,
the first lens, the second lens, the third lens, and each lens in the microlens array are aspheric,
the first surface is planar, and a radius of another surface of the first lens is between 35 to 45 millimeters (mm),
a radius of a surface of the second lens is between 300 to 500 mm, and a radius of another surface of the second lens is between 50 to 90 mm,
a radius of a surface of the third lens is between 40 to 70 mm, and a radius of another surface of the third lens is between −60 to −95 mm, and
a radius of a surface of each lens in the microlens array is between 0.5 to 1 mm.

9. The display system according to claim 8, wherein a distance between the first and second lenses ranges from 2 to 3 mm, a distance between the second and third lenses ranges from 0.2 to 1 mm, and a distance between the microlens array to the display device ranges from 1 to 2 mm.

10. The display system according to claim 4, wherein the reflective polarizer is attached to the first surface of the plurality of surfaces, and the beam splitter is attached to the second surface of the plurality of surfaces.

11. A method for three-dimensional (3D) display, comprising:
calculating a projection of each of a plurality of target relay images based on optical parameters of a display system including a microlens array, each of the plurality of target relay images including an array of intensity values representing an optical image to be formed by the microlens array, the projection being a calculated image array corresponding to an image to be displayed on a surface of a display device, each projection being a conjugate of the respective target relay image in the plurality of target relay images;
determining a total calculated image array based on the calculated image arrays;
generating a display image on the surface of the display device based on the total calculated image array;
forming, by the microlens array, a plurality of relay images from the display image on the surface of the display device, each of the plurality of relay images being an optical image corresponding to a respective one of the plurality of target relay images; and
forming a plurality of virtual images by an optical system, each of the plurality of virtual images corresponding to a respective one of the plurality of relay images, the microlens array being disposed between the optical system and the display device.

12. The method according to claim 11, wherein
the microlens array includes a two-dimensional array of lenses configured to form the plurality of relay images based on light beams from the display device that correspond to the display image, and
the optical system includes:
one or more lenses including a plurality of surfaces, and
one or more polarization-selective elements,
wherein
the plurality of relay images are located at different positions along an optical axis of the display system; and
the plurality of virtual images are located at different virtual positions along the optical axis of the display system.

13. The method according to claim 12, wherein
the method includes directing, by the optical system, light beams corresponding to the plurality of relay images to a light receiver,
the optical system has a first focal plane on a side of the light receiver and a second focal plane on a side of the plurality of relay images, and
the light receiver is located at the first focal plane of the optical system, chief rays from one of the plurality of relay images are substantially parallel to the optical axis, and the chief rays arrive at an intersect of the light receiver and the optical axis.

14. The method according to claim 12, wherein
the one or more polarization-selective elements include:
a film including a reflective polarizer configured to pass through light having a first linear polarization state and reflect light having a second linear polarization state that is orthogonal to the first linear polarization state, the reflective polarizer being disposed over a first surface of the plurality of surfaces,
a beam splitter configured to partially transmit and partially reflect the light beams from the display device, the beam splitter being disposed over a second surface of the plurality of surfaces, and
a first quarter waveplate (QWP) that is positioned between the beam splitter and the reflective polarizer,
the one or more lenses include a first lens and at least one second lens that is between the first lens and the microlens array,
the first surface is on the first lens and faces the at least one second lens, the second surface is on the at least one second lens,
the display system includes the display device, and
the generating the display image includes emitting light beams by a pixel array in the display device, the light beams corresponding to the display image.

15. The method according to claim 14, wherein
an optical cavity is formed between the beam splitter and the reflective polarizer,
the optical cavity includes the at least one second lens and a gap between the first lens and the at least one second lens, and
the method includes:
partially transmitting one of the light beams having a first circular polarization state by the beam splitter,
after the one of the light beams passes the optical cavity for a first time, converting the first circular polarization state of the one of the light beams to the second linear polarization state by the first QWP,
reflecting the one of the light beams having the second linear polarization state by the reflective polarizer,
after the one of the light beams passes the optical cavity for a second time, reflecting the one of the light beams by the beam splitter, the reflected one of the light beams having a second circular polarization state,
after the one of the light beams having the second circular polarization state passes the optical cavity for a third time, converting the second circular polarization state of the one of the light beams to the first linear polarization state by the first QWP, and
transmitting the one of the light beams having the first linear polarization state by the reflective polarizer such that the one of the light beams is directed to a light receiver.

16. The method according to claim 15, wherein
the film further includes the first QWP, and
the first QWP is attached to the reflective polarizer, and the reflective polarizer is disposed between the first surface and the first QWP.

17. The method according to claim 16, wherein
the film further includes a polarizer and an anti-reflection film,
the polarizer is attached to the first surface, and
the first QWP is disposed between the reflective polarizer and the anti-reflection film.

18. The method according to claim 15, wherein the display system includes a panel that includes:
a polarizer configured to convert the light beams from the display device to a linearly polarized light,
a second QWP configured to convert the linearly polarized light beams to the light beams having the first circular polarization state, and
an anti-reflection film, the panel being disposed between the display device and the beam splitter.

19. The method according to claim 15, wherein
the at least one second lens includes a second lens and a third lens,
the first lens, the second lens, the third lens, and each lens in the microlens array are aspheric,
the first surface is planar, and a radius of another surface of the first lens is between 35 to 45 millimeters (mm),
a radius of a surface of the second lens is between 300 to 500 mm, and a radius of another surface of the second lens is between 50 to 90 mm,
a radius of a surface of the third lens is between 40 to 70 mm, and a radius of another surface of the third lens is between −60 to −95 mm,
a radius of a surface of each lens in the microlens array is between 0.5 to 1 mm, the reflective polarizer is attached to the first surface of the plurality of surfaces, and
the beam splitter is attached to the second surface of the plurality of surfaces.

20. The method according to claim 19, wherein a distance between the first and second lenses ranges from 2 to 3 mm, a distance between the second and third lenses ranges from 0.2 to 1 mm, and a distance between the microlens array to the display device ranges from 1 to 2 mm.
